(19) United States
(12) Patent Application Publication
(10) Pub. No.: US 2022/0045457 A1
(43) Pub. Date: Feb. 10, 2022

(54) ELECTROMAGNETIC CONNECTORS

(71) Applicant: Hewlett-Packard Development Company, L.P., Spring, TX (US)

(72) Inventors: Po-Feng Chuang, Taipei City (TW); Wen-Chih Chen, Taipei City (TW); Jing-Ming Chen, Taipei City (TW)

(73) Assignee: Hewlett-Packard Development Company, L.P., Spring, TX (US)

(21) Appl. No.: 17/296,484

(22) PCT Filed: Jan. 9, 2019
(86) PCT No.: PCT/US2019/012802

§ 371 Date: May 24, 2021

(51) Int. Cl. H01R 13/62; G06F 1/16; H01R 13/641; H01R 13/66

(52) U.S. Cl. CPC H01R 13/6205; G06F 1/1633; H01R 13/639; H01R 13/665; H01R 2201/06; H01R 13/641

(57) ABSTRACT

In one example, an electronic device may include a power adapter having a connector plug. Further, the electronic device may include a housing and a connector port disposed on a side of the housing to receive the connector plug of the power adapter. The connector port may include an electromagnet disposed on a mating end of the connector port and a first conductive contact disposed on the mating end and electrically connected to the electromagnet. When the connector port being mated with the connector plug, the first conductive contact may receive power from a second conductive contact of the connector plug and energize the electromagnet to produce magnetic attraction with a magnetic element in the connector plug.

### BACKGROUND

Connectors may be used to couple power and/or data transmission cords or cables to a variety of electronic devices, such as notebook computers, cellular phones, tablet computers, and the like. Such electronic devices may receive power and/or share data using various cables. These cables may have connector inserts, or plugs, on each end. The connector inserts may plug into connector receptacles on electronic devices, thereby forming conductive paths for signals and/or power.

### BRIEF DESCRIPTION OF THE DRAWINGS

Examples are described in the following detailed description and in reference to the drawings, in which:

FIG. 1A is a perspective-view of a portion of an example electronic device, depicting an example connector port having an electromagnet and a first conductive contact;

FIG. 1B is a perspective-view of the portion of the example electronic device of FIG. 1A, depicting the example connector port that can be connected to an example power adapter;

FIG. 2A is a perspective-view of a portion of an example electronic device, depicting another example connector port having an electromagnet, and first and second conductive contacts;

FIG. 2B is a perspective-view of the portion of the example electronic device of FIG. 2A, depicting the example connector port that can be connected to an example power adapter;

FIG. 3A is a perspective-view of a portion of an example electronic device, depicting yet another example connector port having a magnetic element disposed therein; and

FIG. 3B is a perspective-view of the portion of the example electronic device of FIG. 3A, depicting the example connector port that can be connected to an example connector plug.

### DETAILED DESCRIPTION

Electronic devices may receive power and/or share data using various cables. Example electronic devices may include portable computing devices, tablets, desktops, all-in-one computers, smartphones, storage devices, portable media players, navigation systems, monitors, and/or other devices. Such cables may have connector inserts, or connector plugs, on each end. The connector inserts may plug into connector receptacles/ports on electronic devices, thereby forming conductive paths for signals and/or power.

For example, an electronic device may use direct current (DC) power supplied from a power adapter connected to an alternating current (AC) power supply. The power adapter may include a transformer (e.g., a power converter circuit), a power cable, and a connector plug. The transformer may further include a plug to connect to the AC power outlet and the connector plug may be connected to the transformer via the power cable. To make the power connection between the transformer and the electronic device, the connector plug may be inserted into a connector port disposed in a housing of the electronic device and attached to a printed circuit board of the internal electronics of the electronic device. Such connectors may use a mechanical or friction fit to couple the connector plug to the connector port. However, such connectors may be sometimes inadvertently decoupled due to an accident such as when a person trips over a cable attached to the connector. Such inadvertent decoupling can result in a broken connector or even damage to the connected electronic device such as by pulling the electronic device off of a table. Also, repeatedly inserting the connector plugs into the connector ports an cause damage to the connector plugs and/or the connector ports.

Some example connector plugs and connector ports may be magnetic. That is, a magnetic connector plug may be magnetically attracted to a magnetic connector port, and the two may be held in place in a direction by the magnetic attraction. However, such connectors may be connected and disconnected thousands of times during a device's lifetime. This may cause a cable to become disconnected from the connector plug or may lead to other mechanical failures. For example, a shell or other housing may become detached from other parts of the connector plug or connector insert. Also, such magnetic connector plugs and/or connector ports may attract metal debris (e.g., an iron staple), which may get stuck inside connector plugs and/or connector ports and damage the electronics associated with the electronic device.

Some example connector plugs and connector ports may be implemented using an electromagnet. For example, the electromagnet in one connector may be energizable to produce magnetic attraction with a magnetic element in a second connector and maintain contact in an electrically conductive relationship. In this example, the electromagnet may be disposed on a connector port of an electronic device and energizable using power from the electronic device or the electromagnet may be disposed in a connector plug of a power adapter and energizable using power from the power adapter. In such cases, the electromagnet may get energized before a physical contact between the connector plug and the connector port and hence may attract metal debris, which can get stuck inside connector plugs and/or connector ports as described above.

Examples described herein may provide a connector port for an electronic device. The connector port may be disposed on a side of an electronic device housing to receive a connector plug of a power adapter. The connector port may include an electromagnet disposed on a mating end of the connector port and a first conductive contact disposed on the mating end and electrically connected to the electromagnet. When the connector port being mated with the connector plug, the first conductive contact may receive power from a second conductive contact of the connector plug and energize the electromagnet to produce magnetic attraction with a magnetic element (e.g., an iron piece) in the connector plug.

Since the electromagnet in one connector (e.g., the connector port) may be energized using power received from the other connector (e.g., the connector plug), the connectors may not be magnetic before mating ends of the connectors contact each other and hence the electromagnet may not attract any metal debris. Further, the connector port and the connector plug described herein may provide an electromagnetic connection, for instance, between an electronic device and a power adapter, which allows the connector port and the connector plug to decouple from each other when a sudden force is applied without resulting in any damage to the connector port or the associated electronic device.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language, means that a particular feature, structure, or characteristic described may be included in at least that one example, but not necessarily in other examples.

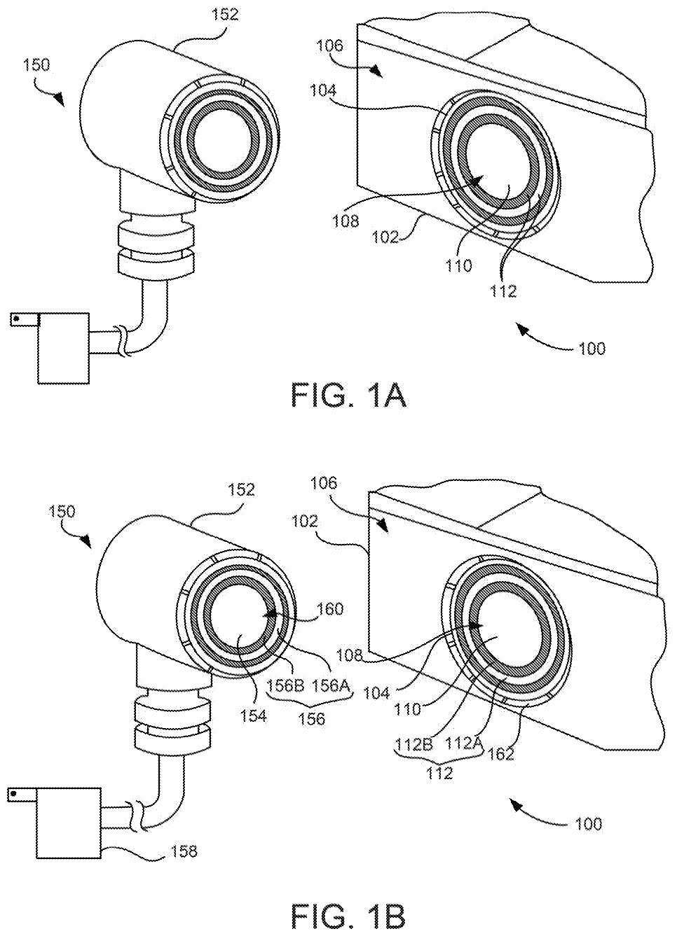

Referring now to the figures, FIG. 1A is a perspective-view of a portion of an example electronic device 100, depicting an example connector port 104 having an electromagnet 110 and a first conductive contact 112. Connector port 104 may be used to transmit/receive power and/or data to or from electronic device 100. For example, connector port 104 can be mated with a connector plug 152 of a power adapter 150 to receive power to charge electronic device 100. Example electronic device 100 may include, but not limited to, a laptop, a convertible device, a personal digital assistance (PDA), a notebook, a sub-notebook, a personal gaming device, a camera, a mobile phone, or any other device that may house electronic components. Example convertible device may refer to a device that can be “converted” from a laptop mode to a tablet mode.

Example electronic device 100 may include power adapter 150 having connector plug 152. Further, example electronic device 100 may include a housing 102 and connector port 104 disposed on a side 106 of housing 102 to receive connector plug 152 of power adapter 150. Example housing 102 may be a keyboard housing, a display housing, or the like. For example, the keyboard housing may house a keyboard, a battery, a touchpad, and so on. The display housing may house a display (e.g., a touchscreen display). Example display may include liquid crystal display (LCD), light emitting diode (LED), electro-luminescent (EL) display, or the like. In other examples, housing 102 may house other components such as a camera, audio/video devices, and the like, depending on the functions of electronic device 100.

Further, connector port 104 may include electromagnet 110 disposed on a mating end 108 of connector port 104. Furthermore, connector port 104 may include first conductive contact 112 disposed on mating end 108 and electrically connected to electromagnet 110. For example, similarly named elements of FIG. 1A may be similar in structure and/or function to elements described below with respect to FIG. 1B.

FIG. 1B is a perspective-view of the portion of example electronic device 100 of FIG. 1A, depicting example connector port 104 that can be connected to example power adapter 150. As shown in FIG. 1B, power adapter 150 may include connector plug 152 having a magnetic element 154 and a second conductive contact 156 disposed on a mating end 160 of connector plug 152. Example magnetic element 154 may be ferromagnetic material (e.g., an iron piece). In one example, power adapter 150 may include a power converter circuit 158 to receive an input power supply and output the power to energize electromagnet 110 via first conductive contact 112 and second conductive contact 156. In some examples, first conductive contact 112 may include a positive (+) contact 112A and a negative (−) contact 112B and second conductive contact 156 may include a corresponding positive (+) contact 156A and a negative (−) contact 156B.

In some examples, connector port 104 and connector plug 152 may be circular in shape. Further, electromagnet 110 may be circular in shape and disposed at a center of mating end 108. Also, first conductive contact 112 may be a circular ring disposed around electromagnet 110 and electrically connected to electromagnet 110. Further, magnetic element 154 may be circular in shape and disposed at a center of mating end 160. Also, second conductive contact 156 may be a circular ring disposed around magnetic element 154 such that second conductive contact 156 can conductively couple to first conductive contact 112 during mating of connector port 104 and connector plug 152.

Housing 102 may include a recessed portion 162, where recessed portion 162 can be sized to receive mating end 160 of connector plug 152 within housing 102 defining recessed portion 162. In this example, inserting connector plug 152 within recessed portion 162 may enable a secure fit and enhanced alignment between connector components (e.g., 154 and 156) of connector plug 152 and corresponding connector components (e.g., 110 and 112) of connector port 104. In other words, connector plug 152 may be sized to fit within recessed portion 162, which ensures alignment of the connector components.

When connector port 104 being mated with connector plug 152, first conductive contact 112 may receive power from second conductive contact 156 of connector plug 152 and energize electromagnet 110 to produce magnetic attraction with magnetic element 154 in connector plug 152. In this example, magnetic force between electromagnet 110 and magnetic element 154 may hold connector plug 152 to connector port 104. For example, the magnetic attraction or force between connector plug 152 and connector port 104 can be varied via modifying the power to electromagnet 110.

When connector port 104 being disconnected from connector plug 152, first conductive contact 112 may electrically disconnect from second conductive contact 156 and de-energize electromagnet 110 so that electromagnet 110 may release magnetic element 154. In this example, both connector port 104 and connector plug 152 can be non-magnetic. In one example, the electromagnetically coupled connector port 104 and connector plug 152 can be decoupled by subjecting to a force that exceeds the electromagnetic force between connector port 104 and connector plug 152. Thus, examples described herein may allow connector port 104 and connector plug 152 to decouple when a sudden force is applied (e.g., when a person trips over an associated cable) without resulting in any damage to connector port 104 connector plug 152, or associated electronic device 100.

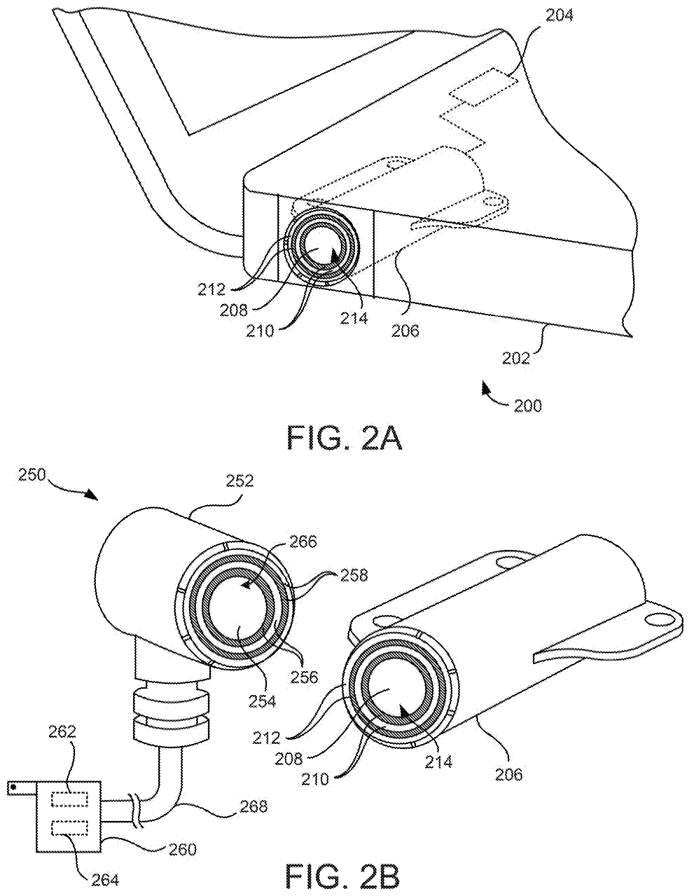

FIG. 2A is a perspective-view of a portion of an example electronic device 200, depicting another example connector port having an electromagnet 208, and first and second conductive contacts 210 and 212. Example electronic device 200 may be a laptop with a display housing pivotally, detachably, or twistably connected to a keyboard housing. Example electronic device 200 may include a housing 202 (e.g., the keyboard housing), an electronic component 204 disposed in housing 202, and a connector port 206 disposed in housing 202 to receive a connector plug.

In one example, connector port 206 may include, electromagnet 208 disposed on a mating end 214 of connector port 206. Further, connector port 206 may include first conductive contact 210 disposed on mating end 214 and electrically connected to electromagnet 208. Furthermore, connector port 206 may include second conductive contact 212 disposed on mating end 214.

When mating end 214 of connector port 206 contacts a mating end of the connector plug:
first conductive contact 210 may receive first power from a third conductive contact of the connector plug and energize electromagnet 208 to produce magnetic attraction with a magnetic element in the connector plug, and
second conductive contact 212 is to conductively couple to a fourth conductive contact of connector plug.

In one example, consider that the connector plug may be associated with an external device such as a portable storage device. In this example, second conductive contact 212 may conductively couple to the fourth conductive contact to communicate data bet ween electronic device 200 and the external device connected to the connector plug.

In another example, consider that the connector plug is associated with a power adapter. In this example, second conductive contact 212 may conductively couple to the fourth conductive contact to receive second power to charge electronic component 204. In some examples, electronic component 204 may be a battery of electronic device 200. In this example, the second power can be greater than first power that is used to energize electromagnet 208.

FIG. 2B is a perspective-view of the portion of example electronic device 200 of FIG. 2A, depicting example connector port 206 that can be connected to an example power adapter 250. As shown in FIG. 2B, power adapter 250 may include connector plug 252 having a magnetic element 254, and third and fourth conductive contacts 256 and 258 disposed on a mating end 266 of connector plug 252.

In the example shown in FIG. 2B, connector plug 252 may be associated with power adapter 250. In one example, power adapter 250 may include a first power converter circuit 262 to receive an input power supply and output the first power to electromagnet 208 via first conductive contact 210 and third conductive contact 256.

Further, power adapter 250 may include a second power converter circuit 264 to receive the input power supply and output the second power to charge electronic component 204 via second conductive contact 212 and fourth conductive contact 258. First power converter circuit 262 and second power converter circuit 264 may be disposed in an adapter portion 260. Connector plug 252 may have third and fourth conductive contacts 256 and 258 for conveying power and/or signals from a power supply, such as adapter portion 260, via wires of a cable 268. For example, the first power may include a voltage of about 12 volts and the second power may include a voltage of about 19.5 volts. Thus, the first power may be received from first power converter circuit 262 to energize electromagnet 208 via first conductive contact 210 and third conductive contact 256, and the second power may be received from second power converter circuit 264 to charge electronic component 204 via second conductive contact 212 and fourth conductive contact 258.

When mating end 214 of connector port 206 is disconnected from mating end 266 of connector plug 252, first conductive contact 210 may electrically disconnect from third conductive contact 256 and de-energize electromagnet 208. In some examples, mating ends 214 and 266 of connector port 206 and connector plug 252, respectively, may be circular in shape. Further, electromagnet 208 and magnetic element 254 may be circular in shape and disposed at a center of respective mating ends 214 and 266. First conductive contact 210 and second conductive contact 212 may be circular rings disposed around electromagnet 208 and may be isolated from each other. Similarly, third conductive contact 256 and fourth conductive contact 258 may be circular rings disposed around magnetic element 254 and may be isolated from each other. Such circular rings on connector port 206 and connector plug 252 may enable first conductive contact 210 and second conductive contact 212 of connector port 206 to align with respective one of third conductive contact 256 and fourth conductive contact 258 of connector plug 252 regardless of the orientation in which connector plug 252 is coupled to connector port 206.

In other examples, connector port 206 and connector plug 252 may include any other shape and/or structure such that electromagnet 208, first conductive contact 210, and second conductive contact 212 of connector port 206 may align with magnetic element 254, third conductive contact 256, and fourth conductive contact 258, respectively, during mating of connector port 206 and connector plug 252. However, to ensure the alignment between the components, connector plug 252 and connector port 206 can have a mechanical structure or a guide that allows for one way of coupling between connector plug 252 and connector port 206. In some examples, each of first conductive contact 210, second conductive contact 212, third conductive contact 256, and fourth conductive contact 258 may include a corresponding positive (+) contact and a negative (−) contact.

In some examples, first conductive contact 210 and second conductive contact 212 may be spring loaded contacts and can be movable to make conductive contacts with third conductive contact 256 and fourth conductive contact 258, respectively. In this example, first conductive contact 210 and second conductive contact 212 may be biased by the springs and extend from mating end 214. Similarly, third conductive contact 256 and fourth conductive contact 258 can be spring loaded contacts.

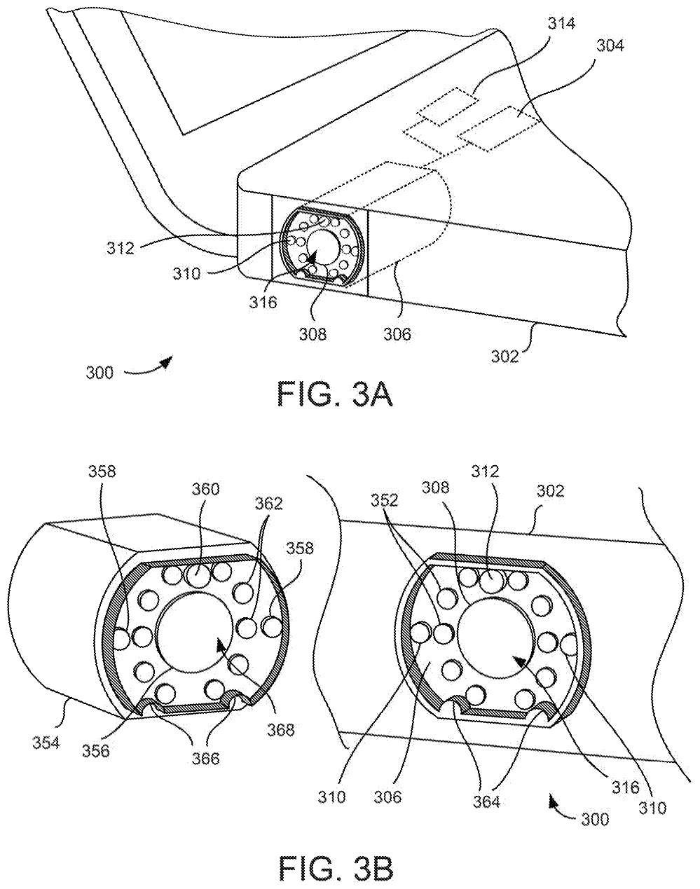

FIG. 3A is a perspective-view of a portion of an example electronic device 300, depicting yet another example connector port 306 having a magnetic element 308 disposed therein. Example magnetic element 308 may include ferromagnetic material, such as iron or steel. Example electronic device 300 may include a housing 302, an electronic component 304 disposed in housing 302, and connector port 306 disposed in housing 302 to receive a connector plug.

In one example, connector port 306 may include magnetic element 308 disposed on a mating end 316 of connector port 306. Further, connector port 306 may include a first conductive contact 310 (e.g., a positive contact and a negative contact) disposed on mating end 316. Furthermore, connector port 308 may include a detect pin 312 disposed on mating end 316. Also, connector port 306 may include a control unit 314. An example operation of FIG. 3A is explained with respect to FIG. 3B.

FIG. 3B is a perspective-view of the portion of example electronic device 300 of FIG. 3A, depicting example connector port 306 that can be connected to an example connector plug 354. As shown in FIG. 3B, connector port 306 may include a third conductive contact 352 disposed on mating end 316. Further, as shown in FIG. 3B, connector plug 354 may include a second conductive contact 358 (e.g., a positive contact and a negative contact), a fourth conductive contact 362, and an electromagnet 356 disposed on a mating end 368 of connector plug 354. Also, connector plug 354 may include another detect pin 360 disposed on mating end 368 of connector plug 354.

Detect pin 312 of connector port 306 may detect an installation of connector plug 354 to connector port 306. In one example, when mating ends 316 and 368 of connector port 306 and connector plug 354 contact each other, detect pin 312 of connector port 306 may conductively contact detect pin 360 of connector plug 354 and hence may become active. Thus, detect pin 312 of connector port 306 may detect the installation of connector plug 354 to connector port 306.

When detect pin 312 detects the installation of connector plug 354 to connector port 306, control unit 314 may enable electronic component 304 (e.g., a system battery) to supply first power to electromagnet 356 in connector plug 354 via conductively coupling first conductive contact 310 with second conductive contact 358. Thus, electromagnet 356 in connector plug 354 may produce magnetic attraction with magnetic element 308 in connector port 306 upon receiving the first power from electronic component 304.

When detect pin 312 detects the installation of connector plug 354 to connector port 306, third conductive contact 352 may conductively couple to fourth conductive contact 362 of connector plug 354 to transfer second power or data. In this example, the second power may be transferred from electronic component 304 of electronic device 300 to an external device or the data may be shared between electronic device 300 and the external device. In other examples, electronic device 300 may receive power from the external device such as a power adapter to charge the battery via third conductive contact 352 and fourth conductive contact 362. In some examples, third conductive contact 352 may include multiple pins to enable power transfer, data transfer, or a combination thereof.

When connector plug 354 is disconnected from connector port 306, first conductive contact 310 may electrically disconnect from second conductive contact 358 and de-energize electromagnet 356. In this example, when detect pin 312 detects a removal of connector plug 354 from connector port 306 (i.e., when detect pin 312 is inactive), control unit 314 may cause electronic component 304 to terminate the first power to first conductive contact 310.

In the example shown in FIG. 3B, connector port 306 may be defined by a sidewall of housing 302 and having a size and shape corresponding to receive connector plug 354 such that detect pin 312, first conductive contact 310, and third conductive contact 352 of connector port 306 may electrically connect to detect pin 360, second conductive contact 358, and fourth conductive contact 362 of connector plug 354, respectively, when mating end 316 of connector port 306 contacts mating end 368 of connector plug 354.

To ensure alignment between connector components, connector plug 354 and connector port 306 can have mechanical structures (e.g., guides 364 on connector port 306 and guides 366 on connector plug 354) that allow for only one way of coupling between connector plug 354 and connector port 306. In other examples, mechanical structures can also be implemented using a protruding feature and a corresponding recess feature on opposite mating ends 316 and 368 to provide one way coupling between connector port 306 and connector plug 354 in a particular orientation.

In one example, control unit 314 may be implemented as engines or modules comprising any combination of hardware and programming to implement the functionalities described herein. In other examples, control unit 314 may be implemented using a control circuitry having a switch element to trigger or terminate power supply to electromagnet 356.

Examples described in FIGS. 1-3 may use an internal elasticity or spring mechanism for conductive contacts and/or pins to enable an enhanced connection between connection components of the connector port and the connector plug during mating of the connector port and the connector plug. For example, first conductive contact 310 and third conductive contact 352 may use an internal elasticity or spring mechanism to enable a connection with second conductive contact 358 and fourth conductive contact 362, respectively, during mating of connector port 306 and connector plug 354. In this example, the springs may allow first conductive contact 310 and third conductive contact 352 to move relative to mating end 316. For example, springs may be compressed during mating of connector port 306 and connector plug 354 to provide an enhanced physical connection between components of connector port 306 and connector plug 354.

It may be noted that he above-described examples of the present solution are for the purpose of illustration only. Although the solution has been described) in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples, it is understood, however, that other forms, details, and examples can be made without departing from the spirit and scope of the present subject matter that is defined in the following claims.

What is claimed is:

1. An electronic device comprising:
a power adapter having a connector plug;
a housing; and
a connector port disposed on a side of the housing to receive the connector plug of the power adapter, the connector port comprising:
an electromagnet disposed on a mating end of the connector port; and
a first conductive contact disposed on the mating end and electrically connected to the electromagnet, wherein when the connector port being mated with the connector plug, the first conductive contact is to receive power from a second conductive contact of the connector plug and energize the electromagnet to produce magnetic attraction with a magnetic element in the connector plug.

2. The electronic device of claim 1, wherein when the connector port being disconnected from the connector plug, the first conductive contact is to electrically disconnect from the second conductive contact and de-energize the electromagnet.

3. The electronic device of claim 1, wherein the power adapter comprises:
a power converter circuit to receive an input power supply and output the power to the electromagnet via the first conductive contact and the second conductive contact.

4. The electronic device of claim 1, wherein the connector port is circular in shape, wherein the electromagnet is circular in shape and disposed at a center of the mating end, and wherein the first conductive contact is a circular ring disposed around the electromagnet.

5. An electronic device comprising:
a housing;
an electronic component disposed in the housing; end
a connector port disposed in the housing to receive a connector plug, the connector port comprising:
an electromagnet disposed on a mating end of the connector port;
a first conductive contact disposed on the mating end and electrically connected to the electromagnet; and
a second conductive contact disposed on the mating end, wherein when the mating end of the connector port contacts a mating end of the connector plug:
the first conductive contact is to receive first power from a third conductive contact of the connector plug and energize the electromagnet to produce magnetic attraction with a magnetic element in the connector plug; and
the second conductive contact is to conductively couple to a fourth conductive contact of the connector plug.

6. The electronic device of claim 5, wherein the second conductive contact is to conductively couple to the fourth conductive contact to receive second power to charge the electronic component, wherein the second power is greater than the first power.

7. The electronic device of claim 6, wherein the connector plug is associated with a power adapter, wherein the first power is received from a first power converter circuit of the power adapter to energize the electromagnet via the first conductive contact and the third conductive contact, and wherein the second power is received from a second power converter circuit of the power adapter to charge the electronic component via the second conductive contact and the fourth conductive contact.

8. The electronic device of claim 5, wherein the second conductive contact is to conductively couple to the fourth conductive contact to communicate data between the electronic device and an external device connected to the connector plug.

9. The electronic device of claim 5, wherein when the mating end of the connector port is disconnected from the mating end of the connector plug, the first conductive contact is to electrically disconnect from the third conductive contact and de-energize the electromagnet.

10. The electronic device of claim 5, wherein the connector port is circular in shape, wherein the electromagnet is circular in shape and disposed at a center of the mating end, and wherein the first conductive contact and the second conductive contact are circular rings disposed around the electromagnet and are isolated from each other.

11. An electronic device comprising:
a housing;
an electronic component disposed in the housing; and
a connector port disposed in the housing to receive a connector plug, the connector port comprising:
a magnetic element disposed on a mating end of the connector port;
a first conductive contact disposed on the mating end;
a detect pin disposed on the mating end to detect an installation of the connector plug to the connector port; and
a control unit, wherein when the detect pin detects the installation of the connector plug, the control unit is to:
enable the electronic component to supply first power to an electromagnet in the connector plug via conductively coupling the first conductive contact with a second conductive contact of the connector plug, wherein the electromagnet is to produce magnetic attraction with the magnetic element upon receiving the first power from the electronic component.

12. The electronic device of claim 11, further comprising:
a third conductive contact disposed on, the mating end, wherein when the detect pin detects the installation of the connector plug to the connector port, the third conductive contact is to conductively couple to a fourth conductive contact of the connector plug to transfer second power or data.

13. The electronic device of claim 12, wherein the connector port is defined by a sidewall of the housing and having a size and shape corresponding to receive the connector plug such that the detect pin, the first conductive contact, and the third conductive contact of the connector port are to electrically connect to a detect pin, the second conductive contact, and the fourth conductive contact of the connector plug, respectively, when the mating end of the connector port contacts the mating end of the connector plug.

14. The electronic device of claim 11, wherein when the connector plug is disconnected from the connector port, the first conductive contact is to electrically disconnect from the second conductive contact and de-energize the electromagnet.

15. The electronic device of claim 14, wherein when the detect pin detects a removal of the connector plug from the connector port, the control unit is to cause the electronic component to terminate the first power to the first conductive contact.
